(19) United States
(12) Patent Application Publication
(10) Pub. No.: US 2026/0045184 A1
(43) Pub. Date: Feb. 12, 2026

(54) DISPLAY DEVICE, ELECTRONIC DEVICE INCLUDING THE DISPLAY DEVICE AND A METHOD OF OPERATING THE DISPLAY DEVICE

(71) Applicant: Samsung Display Co., LTD., Yongin-si (KR)

(72) Inventors: HYOMIN KIM, Yongin-si (KR); YEJI LEE, Yongin-si (KR)

(21) Appl. No.: 19/094,869

(22) Filed: Mar. 29, 2025

(30) Foreign Application Priority Data
Aug. 7, 2024 (KR) 10-2024-0105152

(51) Int. Cl. G09G 3/00; G09G 3/20

(52) U.S. Cl. CPC G09G 3/003; G09G 3/2092; G09G 2320/0233; G09G 2320/0242; G09G 2320/028; G09G 2320/0626; G09G 2320/0686

(57) ABSTRACT

An electronic device includes: a beam splitter, a display device configured to output an image to the beam splitter, and an angle controller configured to control an angle of a display panel included in the display device. The display device includes the display panel including first and second display regions, a data driver configured to apply a data voltage based on a data signal to the display panel, a gate driver configured to output a gate signal to the display panel and a driving controller configured to output the data signal to the data driver. A region angle, which is an angle between the first display region and the second display region, is changed based on an angle control signal. The driving controller changes a setting luminance of at least one of the first display region and the second display region based on the angle control signal.

This application claims priority to Korean Patent Application No. 10-2024-0105152, filed on Aug. 7, 2024, and all the benefits accruing therefrom under 35 U.S.C. § 119, the content of which in its entirety is herein incorporated by reference.

### BACKGROUND

### 1. Field

Embodiments of the present invention relate to a display device, an electronic device including the display device and a method of operating the display device. More particularly, embodiments of the present invention relate to a display device improving the display quality.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

Generally, a three-dimensional image may be outputted by beam splitter included in an electronic device.

### SUMMARY

Embodiments of the present invention provide a display device improving a display quality of a three-dimensional image.

Embodiments of the present invention also provide an electronic device including the display device.

Embodiments of the present invention also provide a method of operating the display device.

According to embodiments, an electronic device includes a beam splitter, a display device configured to output an image to the beam splitter and an angle controller configured to control an angle of a display panel included in the display device. The display device includes the display panel including a first display region and a second display region, a data driver configured to apply a data voltage based on a data signal to the display panel, a gate driver configured to output a gate signal to the display panel and a driving controller configured to output the data signal to the data driver. A region angle, which is an angle between the first display region and the second display region, is changed based on an angle control signal. The driving controller changes a setting luminance of at least one of the first display region and the second display region based on the angle control signal.

In an embodiment, wherein when a portion of the region angle, which is an angle between a current position of the second display region and a reference position of the second display region, may have a first region angle, the second display region emits light based on a first setting luminance. When the portion of the region angle is changed from the first region angle to a second region angle higher than the first region angle, a white color coordinate corresponding to white color of the second display region may be changed from a first white color coordinate corresponding to the first region angle to a second white color coordinate different from the first white color coordinate.

In an embodiment, an X-axis coordinate of the second white color coordinate may be lower than an X-axis coordinate of the first white color coordinate, and a Y-axis coordinate of the second white color coordinate may be lower than a Y-axis coordinate of the first white color coordinate.

In an embodiment, when the portion of the region angle has a third region angle higher than the second region angle, the white color coordinate may be changed to a third white color coordinate different from the second white color coordinate.

In an embodiment, an X-axis coordinate of the third white color coordinate may be lower than the X-axis coordinate of the second white color coordinate, and a Y-axis coordinate of the third white color coordinate may be higher than the Y-axis coordinate of the second white color coordinate.

In an embodiment, when the portion of the region angle has a fourth region angle higher than the third region angle, the white color coordinate may be changed to a fourth white color coordinate different from the third white color coordinate.

In an embodiment, an X-axis coordinate of the fourth white color coordinate may be higher than the X-axis coordinate of the third white color coordinate, and a Y-axis coordinate of the fourth white color coordinate may be higher than the Y-axis coordinate of the third white color coordinate.

In an embodiment, when the portion of the region angle has a first region angle, the second display region may emit light based on a first setting luminance. When the portion of the region angle has a second region angle higher than the first region angle, the second display region may emit light based on a second setting luminance higher than the first setting luminance.

In an embodiment, when the portion of the region angle has a third region angle higher than the second region angle, the second display region may emit light based on a third setting luminance higher than the second setting luminance.

In an embodiment, the driving controller may include an angle data receiver configured to output an angle information signal based on region angle data, a luminance change determiner configured to output luminance compensation data corresponding to the region angle based on the angle information signal and a data signal outputter configured to output the data signal based on the luminance compensation data.

In an embodiment, the luminance compensation data may be generated based on a luminance compensation look-up table.

In an embodiment, the driving controller may include an angle data receiver configured to output an angle information signal based on region angle data, a color coordinate change determiner configured to output color coordinate compensation data corresponding to the region angle based on the angle information signal and a data signal outputter configured to output the data signal based on the color coordinate compensation data.

In an embodiment, the color coordinate compensation data may be generated based on a color coordinate compensation look-up table.

In an embodiment, the display panel may further include a third display region. An angle between the first display region and the third display region may be changed based on an angle control signal.

In an embodiment, the beam splitter may output a three-dimensional image.

In an embodiment, the region angle may be changed in real-time.

According to embodiments, a display device includes a display panel including a first display region and a second display region, a data driver configured to apply a data voltage based on a data signal to the display panel, a gate driver configured to output a gate signal to the display panel and a driving controller configured to output the data signal to the data driver. A region angle, which is an angle between the first display region and the second display region, is changed based on an angle control signal. The driving controller changes a setting luminance of at least one of the first display region and the second display region based on the angle control signal.

In an embodiment, when a portion of the region angle, which is an angle between a current position of the second display region and a reference position of the second display region, has a first region angle, the second display region may emit light based on a first setting luminance. When the portion of the region angle is changed from the first region angle to a second region angle higher than the first region angle, a white color coordinate corresponding to white color of the second display region may be changed from a first white color coordinate corresponding to the first region angle to a second white color coordinate different from the first color coordinate. An X-axis coordinate of the second white color coordinate may be lower than an X-axis coordinate of the first white color coordinate, and a Y-axis coordinate of the second white color coordinate may be lower than a Y-axis coordinate of the first white color coordinate.

According to embodiments, a method of operating a display panel includes: receiving region angle data, determining color coordinate compensation data based on the region angle data, and outputting a data signal based on the color coordinate compensation data. The color coordinate compensation data is generated based on a color coordinate compensation look-up table. When a region angle of a display region included in a display panel is changed from the first region angle to a second region angle higher than a first region angle, a white color coordinate corresponding to white color of the display region is changed from a first white color coordinate corresponding to the first region angle to a second white color coordinate different from the first color coordinate. An X-axis coordinate of the second white color coordinate is lower than an X-axis coordinate of the first white color coordinate, and a Y-axis coordinate of the second white color coordinate is lower than a Y-axis coordinate of the first white color coordinate.

In an embodiment, when the region angle of the display region has a third region angle higher than the second region angle, the white color coordinate may be changed to a third white color coordinate different from the second white color coordinate. An X-axis coordinate of the third white color coordinate may be lower than the X-axis coordinate of the second white color coordinate, and a Y-axis coordinate of the third white color coordinate may be higher than the Y-axis coordinate of the second white color coordinate.

As described above, a setting luminance of a first display region and/or a setting luminance of a second display region may be changed based on region angles. Accordingly, a luminance change according to a change in the region angle may be reflected in the image outputted by the display panel. Accordingly, a display quality of a three-dimensional image outputted by a beam splitter may be effectively improved.

Additionally, a white color coordinate of a first display region and/or a white color coordinate of a second display region may be changed based on region angles. Accordingly, a color coordinate change according to a change in the region angle may be reflected in the image outputted by the display panel. Accordingly, a display quality of a three-dimensional image outputted by a beam splitter may be effectively improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an electronic device according to embodiments of the present invention.

FIG. 2 is a block diagram illustrating a display device according to embodiments of the present invention.

FIG. 3 is a diagram illustrating an example of a display panel and a beam splitter included in an electronic device of FIG. 1.

FIG. 4 is a graph illustrating a luminance change of an image applied to a beam splitter according to a change of a region angle.

FIG. 5 is a block diagram illustrating an example of a driving controller included in a display device of FIG. 2.

FIG. 6 is a table illustrating a luminance compensation look-up table included in a luminance change determiner of FIG. 5.

FIG. 7 is a graph illustrating a change of a white color coordinate according to a change of a region angle.

FIG. 8 is a graph illustrating a change variance of a white color coordinate of an image applied to a beam splitter according to a change of a region angle.

FIG. 9 is a block diagram illustrating another example of a driving controller included in a display device of FIG. 2.

FIG. 10 is a table illustrating a color coordinate compensation look-up table included in a color coordinate change determiner of FIG. 9.

FIG. 11 is a diagram illustrating another example of a display panel and a beam splitter included in an electronic device of FIG. 1.

FIG. 12 is a flow-chart illustrating a method of generating a data signal based on an angle control signal.

FIG. 13 is a block diagram illustrating an electronic device according to an embodiment.

### DETAILED DESCRIPTION

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an. ” “Or” means “and/or. ” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

“About” or “substantially the same” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10%, 5% or 2% of the stated value.

Hereinafter, the present invention will be explained in detail with reference to the accompanying drawings.

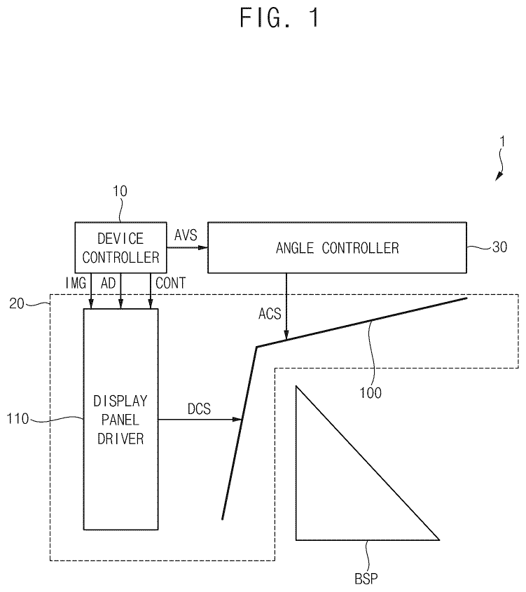

FIG. 1 is a block diagram illustrating an electronic device 1 according to embodiments of the present invention.

Referring to FIG. 1, an electronic device 1 may include a device controller 10, a display device 20, an angle controller 30 and a beam splitter BSP.

The device controller 10 may drive a display panel driver 110 and the angle controller 30. The device controller 10 may output input image data IMG and an input control signal CONT to the display panel driver 110. The device controller 10 may output an angle change signal AVS to the angle controller 30.

The display device 20 may include display panel 100 and a display panel driver 110. The display panel 100 may display an image based on the input image data IMG. The display panel driver may operate the display panel 100. For example, the display panel driver 110 may control the display panel 100 based on a panel control signal DCS. The display panel 100 may output the image to the beam splitter BSP based on the input image data IMG.

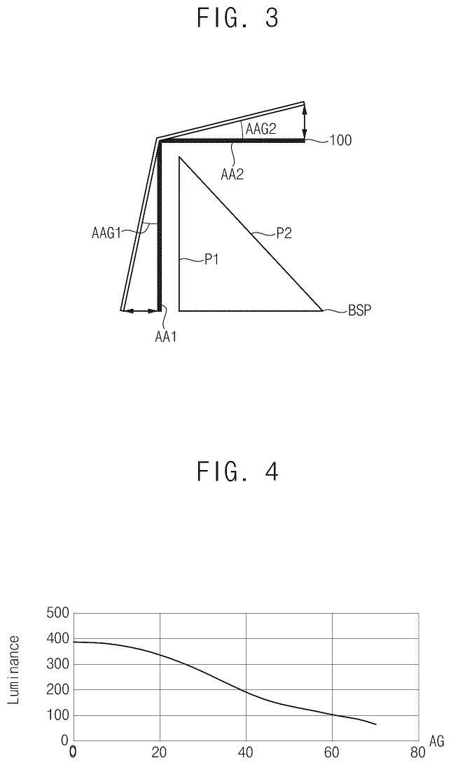

The angle controller 30 may control an angle of the display panel 100 based on the angle change signal AVS. The angle controller 30 may control an angle between the first display region AA1 of FIG. 3 and the second display region AA2 of FIG. 3. In an embodiment, the angle controller 30 may control the angle of the display panel 100 in a real-time. Accordingly, the angle of the display panel 100 may be controlled in a real-time.

The beam splitter BSP may output a three-dimensional image based on the image outputted from the display panel 100. For example, the beam splitter BSP may transmit half of the incident light and reflect the other half. For example, the beam splitter BSP may reflect and transmit light regardless of the polarization characteristics of light. The beam splitter BSP may output the three-dimensional image based on a first region image outputted from the first display region AA1 and a second region image output from the second display region AA2. For example, the first region image may be outputted to a first surface P1 of the beam splitter BSP. For example, the second region image may be outputted to a second surface P2 different from the first surface P1 of the beam splitter BSP.

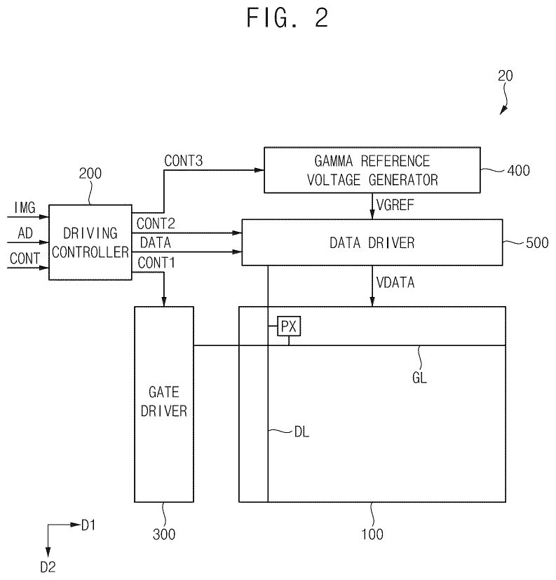

FIG. 2 is a block diagram illustrating a display device 20 according to embodiments of the present invention.

Referring to FIG. 1 to FIG. 2, the display device 20 may include a display panel 100 and a display panel driver. The display panel driver may include a driving controller 200, a gate driver 300, a gamma reference voltage generator 400 and a data driver 500.

The display panel 100 may have a display region on which an image is displayed and a peripheral region adjacent to the display region. The display panel 100 may include the first display region AA1 and the second display region AA2. The display panel 100 according to the present invention may be flexible display panel and/or rigid display panel. For example, the display panel 100 may be a foldable display panel which folds based on a folding axis.

The display panel 100 may include a plurality of gate lines GL, a plurality of data lines DL and a plurality of pixels PX electrically connected to the gate lines GL and the data lines DL. The gate lines GL may extend in a first direction D1, and the data lines DL may extend in a second direction D2 crossing the first direction D1.

The driving controller 200 may receive input image data IMG and an input control signal CONT from an external apparatus. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The gate driver 300 may generate gate signals driving the gate lines GL in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL. In an embodiment, the data driver 500 may further output a pulse data voltage PWVDATA. In an embodiment, the data driver 500 may generate a data current based on the data signal DATA. In an embodiment, the data driver 500 may output the data current to the data driver 500.

In an embodiment, the data driver 500 may be disposed in the peripheral region. In an embodiment, the data driver 500 may be integrated in the peripheral region.

FIG. 3 is a diagram illustrating an example of a display panel 100 and a beam splitter BSP included in an electronic device 1 of FIG. 1.

Referring to FIG. 1 to FIG. 3, the angle between the first display region AA1 and the second display region AA2 may be changed. For example, the first display region AA1 and the second display region AA2 may be positioned to form a reference region angle therebetween. The “reference region angle” may refer to as a case where the angle between the first display region AA1 and the second display region AA2 is about 90 degrees. An angle of the first display region AA1 may be changed from a reference position forming the reference region angle. The changed angle of the first display region AA1 with respect to the reference position may be defined as a “first display region angle” AAG1. An angle of the second display region AA2 may be changed from a reference position forming the reference region angle. The changed angle of the second display region AA2 with respect to the reference position may be defined as a “second display region angle” AAG2.

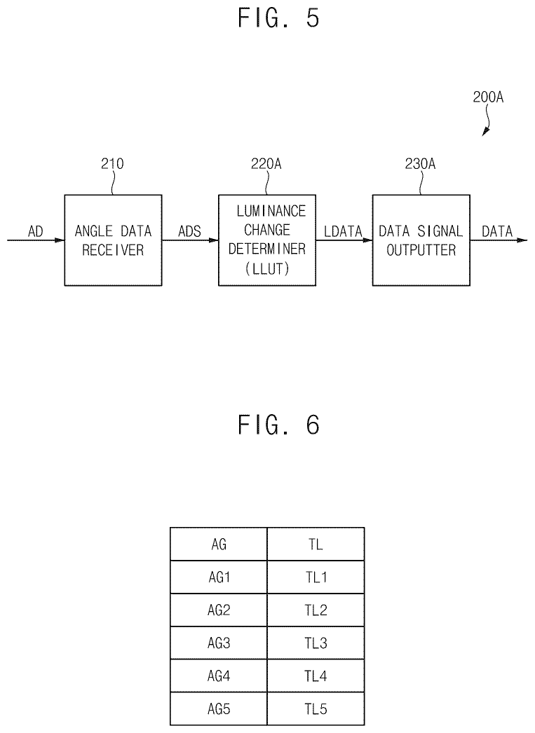

FIG. 4 is a graph illustrating a luminance change of an image applied to a beam splitter BSP according to a change of a region angle AG. FIG. 5 is a block diagram illustrating an example of a driving controller 200 included in a display device 20 of FIG. 2. FIG. 6 is a table illustrating a luminance compensation look-up table LLUT included in a luminance change determiner 220A of FIG. 5.

Referring to FIG. 1 to FIG. 6, the driving controller 200A may include an angle data receiver 210, a luminance change determiner 220A and a data signal outputter 230A.

The angle data receiver 210 may receive region angle data AD from the device controller 10. The region angle data AD may include data of the first display region angle AAG1. The region angle data AD may include data of the second display region angle AAG2. The angle data receiver 210 may output an angle information signal ADS based on the region angle data AD.

The luminance change determiner 220A may receive the angle information signal ADS. The luminance change determiner 220A may output luminance compensation data LDATA based on the angle information signal ADS. The luminance compensation data LDATA may correspond to the first display region angle AAG1. The luminance compensation data LDATA may correspond to the second display region angle AAG2. In an embodiment, the luminance compensation data LDATA may be generated based on the luminance compensation look-up table LLUT.

For example, when the second display region angle AAG2 has a first region angle AG1, a setting luminance of the second display region AA2 may be a first setting luminance TL1. For example, the first region angle AG1 may be about 0 degree in which the second display region AA2 is positioned at the reference position forming the reference region angle. For example, the first setting luminance TL1 may be called as a reference setting luminance. When the second display region angle AAG2 has about 0 degree, the luminance compensation data LDATA may correspond to the first setting luminance TL1. For example, the setting luminance may mean the maximum luminance in which the display panel 100 may display. For example, the setting luminance may mean the maximum luminance that the display panel 100 may display a grayscale corresponding to white. For example, the grayscale corresponding to white may be about 255 grayscale level. However, the present invention is not limited to the value of the grayscale corresponding to white. For example, the setting luminance may be about 3000 nit. For example, the setting luminance may be about 600 nit. However, the present invention is not limited to the value of the setting luminance. For example, when the first display region angle AAG1 is about 0 degree in which the first display region AA1 is positioned at the reference position forming the reference region angle, the setting luminance of the first display region AA1 may be the first setting luminance TL1. When the first display region angle AAG1 has the first region angle AG1, the luminance compensation data LDATA may be data corresponding to the first setting luminance TL1.

For example, when the second display region angle AAG2 has a second region angle AG2, a setting luminance of the second display region AA2 may be a second setting luminance TL2. The second setting luminance TL2 may be higher than the first setting luminance TL1. For example, the second region angle AG2 may be about 20 degrees. When the second display region angle AAG2 has the second region angle AG2, the luminance compensation data LDATA may correspond to the second setting luminance TL2. For example, when the first display region angle AAG1 has the second region angle AG2, the setting luminance of the first display region AA1 may be the second setting luminance TL2.

For example, when the second display region angle AAG2 has a third region angle AG3, a setting luminance of the second display region AA2 may be a third setting luminance TL3. The third setting luminance TL3 may be higher than the second setting luminance TL2. For example, the third region angle AG3 may be about 40 degrees. When the second display region angle AAG2 has the third region angle AG3, the luminance compensation data LDATA may correspond to the third setting luminance TL3. For example, when the first display region angle AAG1 has the third region angle AG3, the setting luminance of the first display region AA1 may be the third setting luminance TL3.

For example, when the second display region angle AAG2 has a fourth region angle AG4, a setting luminance of the second display region AA2 may be a fourth setting luminance TL4. The fourth setting luminance TL4 may be higher than the third setting luminance TL3. For example, the fourth region angle AG4 may be about 60 degrees. When the second display region angle AAG2 has the fourth region angle AG4, the luminance compensation data LDATA may correspond to the fourth setting luminance TL4. For example, when the first display region angle AAG1 has the fourth region angle AG4, the setting luminance of the first display region AA1 may be the fourth setting luminance TL4.

For example, when the second display region angle AAG2 has a fifth region angle AG5, a setting luminance of the second display region AA2 may be a fifth setting luminance TL5. The fifth setting luminance TL5 may be higher than the fourth setting luminance TL4. For example, the fifth region angle AG5 may be about 80 degrees. When the second display region angle AAG2 has the fifth region angle AG5, the luminance compensation data LDATA may correspond to the fifth setting luminance TL5. For example, when the first display region angle AAG1 has the fifth region angle AG5, the setting luminance of the first display region AA1 may be the fifth setting luminance TL5.

When the region angles change, an angle between the plane of the beam splitter BSP and the display region may change. Accordingly, the luminance of the image applied to the beam splitter BSP may decrease. Accordingly, a display quality of the three-dimensional image outputted by the beam splitter BSP may deteriorated. In the present embodiment, the setting luminance of the first display region AA1 and/or the setting luminance of the second display region AA2 may be changed based on the region angles. Accordingly, the luminance change according to the change in the region angle may be reflected in the image outputted by the display panel 100. Accordingly, a display quality of the three-dimensional image outputted by the beam splitter BSP may be effectively improved.

The data signal outputter 230A may receive the luminance compensation data LDATA. The data signal outputter 230A may output the data signal DATA based on the luminance compensation data LDATA. The data driver 500 may generate the data voltage VDATA based on the data signal DATA. The pixel circuit PX may emit light based on the data voltage VDATA. In the present embodiment, the data signal DATA may be generated based on the luminance compensation data LDATA, so that the display panel 100 may emit light as a setting luminance based on a region angle. Accordingly, a display quality of the three-dimensional image outputted from the beam splitter BSP may be effectively improved.

Additionally, in the present embodiment, the electronic device 1 may output the three-dimensional image by using one display panel 100. Accordingly, the number of the display panel 100 included in the electronic device 1 may be reduced.

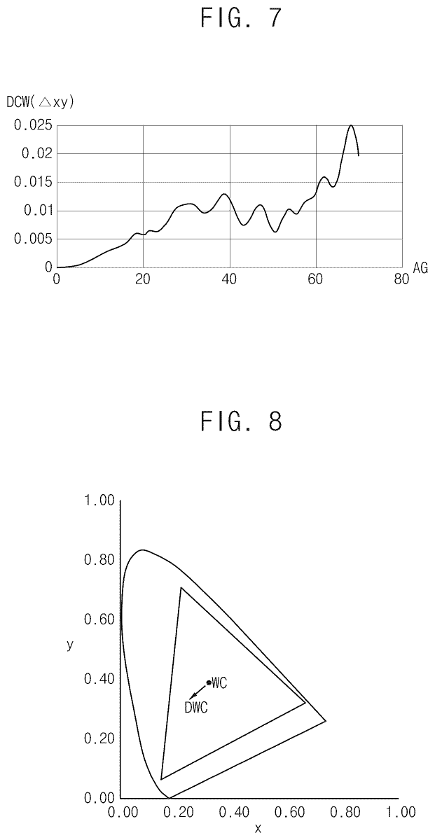

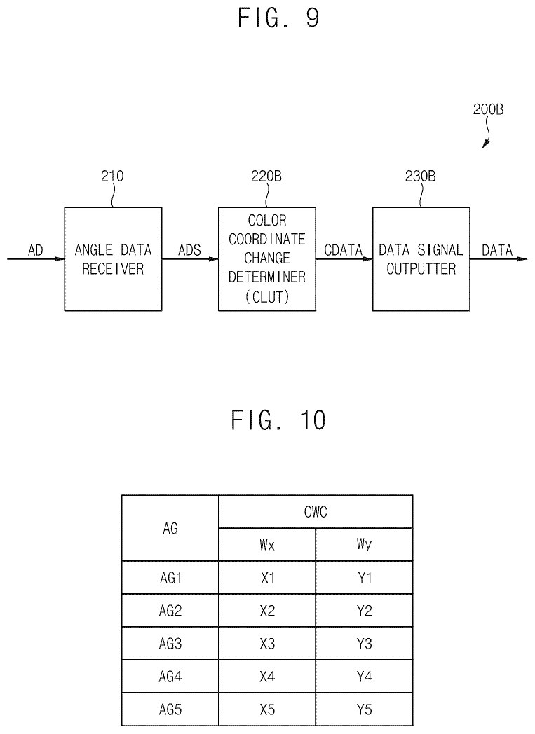

FIG. 7 is a graph illustrating a change of a white color coordinate WC according to a change of a region angle AG. FIG. 8 is a graph (e.g., CIE coordinates) illustrating a change variance of a white color coordinate WC of an image applied to a beam splitter BSP according to a change of a region angle AG. FIG. 9 is a block diagram illustrating another example of a driving controller 200 included in a display device 20 of FIG. 2. FIG. 10 is a table illustrating a color coordinate compensation look-up table CLUT included in a color coordinate change determiner 220B of FIG. 9.

Referring to FIG. 1 to FIG. 4 and FIG. 7 to FIG. 10, the angle data receiver 210 may receive the region angle data AD from the device controller 10. The region angle data AD may include data of the first display region angle AAG1. The region angle data AD may include data of the second display region angle AAG2. The angle data receiver 210 may output the angle information signal ADS based on the region angle data AD.

The color coordinate change determiner 220B may receive the angle information signal ADS. The color coordinate change determiner 220B may output color coordinate compensation data CDATA based on the angle information signal ADS. The color coordinate compensation data CDATA may correspond to the first display region angle AAG1. The color coordinate compensation data CDATA may correspond to the second display region angle AAG2. In an embodiment, the color coordinate compensation data CDATA may be generated based on the color coordinate compensation look-up table CLUT.

For example, when the second display region angle AAG2 has the first region angle AG1, a white color coordinate CWC of the second display region AA2 may be a first white color coordinate. For example, the first white color coordinate may be called as a reference white color coordinate. When the second display region angle AAG2 is about 0 degree in which the second display region AA2 is positioned at the reference position forming the reference region angle, the color coordinate compensation data CDATA may correspond to the first white color coordinate. For example, when the first display region angle AAG1 has the first region angle AG1, the white color coordinate CWC of the first display region AA1 may be the first white color coordinate. When the first display region angle AAG1 has the first region angle AG1, the white color coordinate compensation data CDATA may be data corresponding to the first white color coordinate.

For example, when the second display region angle AAG2 has the second region angle AG2, the white color coordinate CWC of the second display region AA2 may be a second white color coordinate. An X-axis coordinate X2 of the second white color coordinate may be lower than an X-axis coordinate X1 of the first white color coordinate, and a Y-axis coordinate Y2 of the second white color coordinate may be lower than a Y-axis coordinate Y1 of the first white color coordinate. When the second display region angle AAG2 has the second region angle AG2, the white color coordinate compensation data CDATA may correspond to the second white color coordinate. For example, when the first display region angle AAG1 has the second region angle AG2, the white color coordinate of the first display region AA1 may be the second white color coordinate. For example, the second region angle AG2 may be about 20 degrees.

For example, when the second display region angle AAG2 has the third region angle AG3, the white color coordinate CWC of the second display region AA2 may be a third white color coordinate. An X-axis coordinate X3 of the third white color coordinate may be lower than an X-axis coordinate X2 of the second white color coordinate, and a Y-axis coordinate Y3 of the third white color coordinate may be lower than a Y-axis coordinate Y2 of the second white color coordinate. When the second display region angle AAG2 has the third region angle AG3, the white color coordinate compensation data CDATA may correspond to the third white color coordinate. For example, when the first display region angle AAG1 has the third region angle AG3, the white color coordinate of the first display region AA1 may be the third white color coordinate. For example, the third region angle AG3 may be about 40 degrees.

For example, when the second display region angle AAG2 has the fourth region angle AG4, the white color coordinate CWC of the second display region AA2 may be a fourth white color coordinate. An X-axis coordinate X4 of the fourth white color coordinate may be lower than an X-axis coordinate X3 of the third white color coordinate, and a Y-axis coordinate Y4 of the fourth white color coordinate may be higher than a Y-axis coordinate Y3 of the third white color coordinate. When the second display region angle AAG2 has the fourth region angle AG4, the white color coordinate compensation data CDATA may correspond to the fourth white color coordinate. For example, when the first display region angle AAG1 has the fourth region angle AG4, the white color coordinate of the first display region AA1 may be the fourth white color coordinate. For example, the fourth region angle AG4 may be about 60 degrees.

For example, when the second display region angle AAG2 has the fifth region angle AG5, the white color coordinate CWC of the second display region AA2 may be a fifth white color coordinate. An X-axis coordinate X5 of the fifth white color coordinate may be higher than an X-axis coordinate X4 of the fourth white color coordinate, and a Y-axis coordinate Y5 of the fifth white color coordinate may be higher than a Y-axis coordinate Y4 of the fourth white color coordinate. When the second display region angle AAG2 has the fifth region angle AG5, the white color coordinate compensation data CDATA may correspond to the fifth white color coordinate. For example, when the first display region angle AAG1 has the fifth region angle AG5, the white color coordinate of the first display region AA1 may be the fifth white color coordinate. For example, the fifth region angle AG5 may be about 80 degrees.

When the region angles change, an angle between the plane of the beam splitter BSP and the display region may change. Accordingly, a color coordinate of the image applied to the beam splitter BSP may decrease. For example, an X-axis coordinate and a Y-axis coordinate of a white color coordinate of the image applied to the beam splitter BSP may be changed. For example, the X-axis coordinate and the Y-axis coordinate of the white color coordinate of the image may be changed by a variance DWC. Accordingly, a display quality of the three-dimensional image outputted by the beam splitter BSP may be deteriorated. In the present embodiment, a white color coordinate of the first display region AA1 and/or a white color coordinate of the second display region AA2 may be changed based on the region angles. Accordingly, the color coordinate change according to the change in the region angle may be reflected in the image outputted by the display panel 100. Accordingly, a display quality of the three-dimensional image outputted by the beam splitter BSP may be effectively improved.

The data signal outputter 230B may receive the color coordinate compensation data CDATA. The data signal outputter 230B may output the data signal DATA based on the color coordinate compensation data CDATA. The data driver 500 may generate the data voltage VDATA based on the data signal DATA. The pixel circuit PX may emit light based on the data voltage VDATA. In the present embodiment, the data signal DATA may be generated based on the color coordinate compensation data CDATA, so that the display panel 100 may emit light as a white color coordinate based on a region angle. Accordingly, a display quality of the three-dimensional image outputted from the beam splitter BSP may be effectively improved.

Additionally, in the present embodiment, the electronic device 1 may output the three-dimensional image by using one display panel 100. Accordingly, the number of the display panel 100 included in the electronic device 1 may be reduced.

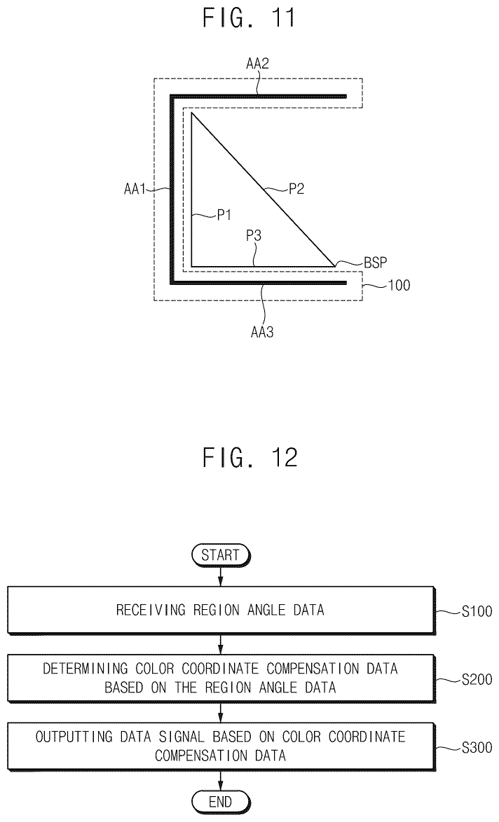

FIG. 11 is a diagram illustrating another example of a display panel 100 and a beam splitter BSP included in an electronic device 1 of FIG. 1.

Referring to FIG. 1 to FIG. 11, the display panel 100 may further include a third display region AA3. The display device 20 according to the present embodiment is substantially same as the display device 20 described with referring to FIG. 1 to FIG. 9, except that the display panel 100 further includes the third display region AA3, so that the same reference numerals will be used and any repetitive explanation concerning the above elements will be omitted.

In the present embodiment, the region angle AG of the third display region AA3 may be changed. When the region angle AG of the third display region AA3 is changed, the data signal DATA may be generated based on the luminance compensation data LDATA. Additionally, when the region angle AG of the third display region AA3 is changed, the data signal DATA may be generated based on the color coordinate compensation data CDATA. Accordingly, the third display region AA3 may emit light as the setting luminance based on the region angle AG. Additionally, the third display region AA3 may emit light as a white color coordinate based on the region angle AG. Accordingly, the display quality of the three-dimensional image outputted by the beam splitter BSP may be effectively improved.

Additionally, the display panel 100 may include a third display region AA3. Accordingly, an image may be outputted to a third plane P3 different from the first plane P1 and the second plane P2 of the beam splitter BSP. Accordingly, the diversity of the three-dimensional image outputted by the electronic device 1 may be effectively improved. Additionally, a display quality of the three-dimensional image outputted from the electronic device 1 may be further improved.

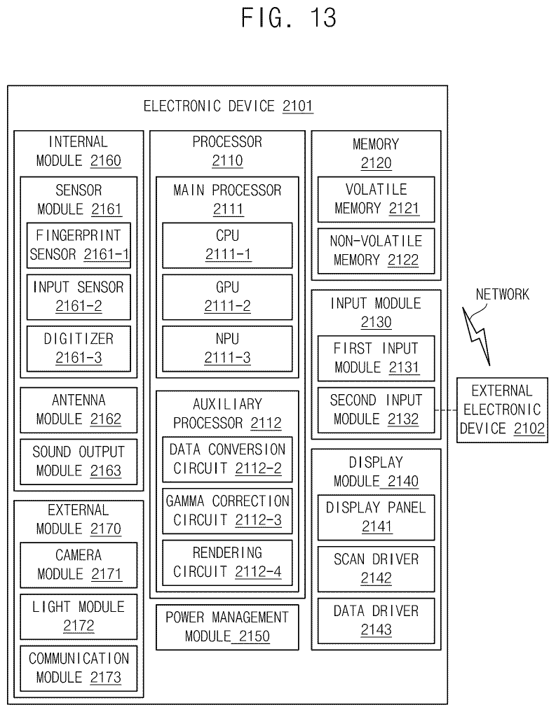

FIG. 12 is a flow-chart illustrating a method of generating a data signal DATA based on an angle control signal ACS.

Referring to FIG. 1 to FIG. 11, the driving controller 200 may receive the angle control signal ACS (S100). The driving controller 200 may determine the color coordinate compensation data CDATA based on the angle control signal ACS (S200). The driving controller 200 may output the data signal DATA based on the color coordinate compensation data CDATA (S300).

When the region angles change, an angle between the plane of the beam splitter BSP and the display region may change. Accordingly, a color coordinate of the image applied to the beam splitter BSP may decrease. For example, an X-axis coordinate and a Y-axis coordinate of a white color coordinate of the image applied to the beam splitter BSP may be changed. For example, the X-axis coordinate and the Y-axis coordinate of the white color coordinate of the image may be changed by a variance DWC. Accordingly, a display quality of the three-dimensional image outputted by the beam splitter BSP may be deteriorated. In the present embodiment, a white color coordinate of the first display region AA1 and/or a white color coordinate of the second display region AA2 may be changed based on the region angles. Accordingly, the color coordinate change according to the change in the region angle may be reflected in the image outputted by the display panel 100. Accordingly, a display quality of the three-dimensional image outputted by the beam splitter BSP may be effectively improved.

Additionally, in the present embodiment, the electronic device 1 may output the three-dimensional image by using one display panel 100. Accordingly, the number of the display panel 100 included in the electronic device 1 may be reduced.

FIG. 13 is a block diagram illustrating an electronic device according to an embodiment 2101.

An electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

As another example, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

As another example, when a music streaming icon displayed on the display module 2140 is selected, the processor 2110 obtains a user input via the input sensor 2161-2 and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component or one component may be provided separately as two or more components.

The electronic device 2101 may communicate with an external electronic device 2102 via a network (e.g., a short-range wireless communication network or a long-range wireless communication network). In an embodiment, the electronic device 2101 may include the processor 2110, the memory 2120, the input module 2130, the display module 2140, a power management module 2150, an internal module 2160 and an external module 2170. In an embodiment, at least one of the components may be omitted from the electronic device 2101 or one or more other components may be added in the electronic device 2101. In an embodiment, some of the components (e.g., the sensor module 2161, an antenna module 2162 or the sound output module 2163) may be implemented as a single component (e.g., the display module 2140).

The processor 2110 may execute software to control at least one other component (e.g., a hardware or software component) of the electronic device 2101 coupled with the processor 2110 and may perform various data processing or computation. According to an embodiment, as at least part of the data processing or computation, the processor 2110 may store a command or data received from another component (e.g., the input module 2130, the sensor module 2161 or a communication module 2173) in volatile memory 2121, may process the command or the data stored in the volatile memory 2121 and may store resulting data in non-volatile memory 2122.

The processor 2110 may include a main processor 2111 and an auxiliary processor 2112. The main processor 2111 may include one or more of a central processing unit (CPU) 2111-1 or an application processor (AP). The main processor 2111 may further include any one or more of a graphics processing unit (GPU) 2111-2, a communication processor (CP) and an image signal processor (ISP). The main processor 2111 may further include a neural processing unit (NPU) 2111-3. The NPU 2111-3 may be a processor specialized in processing an artificial intelligence model and the artificial intelligence model may be generated through machine learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof, but is not limited thereto. The artificial intelligence model may, additionally or alternatively, include a software structure other than a hardware structure. At least two of the above-described processing units and processors may be implemented as an integrated component (e.g., a single chip) or respective processing units and processors may be implemented as independent components (e.g., a plurality of chips).

The auxiliary processor 2112 may include a controller. The controller may include an interface conversion circuit and a timing control circuit. The controller may receive an image signal from the main processor 2111, may convert a data format of the image signal to meet interface specifications with the display module 2140 and may output image data. The controller may output various control signals required for driving the display module 2140.

The auxiliary processor 2112 may further include a data conversion circuit 2112-2, a gamma correction circuit 2112-3, a rendering circuit 2112-4 or the like. The data conversion circuit 2112-2 may receive image data from the controller. The data conversion circuit 2112-2 may compensate for the image data such that an image is displayed with a desired luminance according to characteristics of the electronic device 2101 or the user's setting or may convert the image data to reduce power consumption or to eliminate an afterimage. The gamma correction circuit 2112-3 may convert image data or a gamma reference voltage so that an image displayed on the electronic device 2101 has desired gamma characteristics. The rendering circuit 2112-4 may receive image data from the controller and may render the image data in consideration of a pixel arrangement of the display panel 2141 in the electronic device 2101. At least one of the data conversion circuit 2112-2, the gamma correction circuit 2112-3 and the rendering circuit 2112-4 may be integrated in another component (e.g., the main processor 2111 or the controller). At least one of the data conversion circuit 2112-2, the gamma correction circuit 2112-3 and the rendering circuit 2112-4 may be integrated in a data driver 2143 described below.

As used in connection with various embodiments of the disclosure, each of the luminance change determiner 220A and the color coordinate change determiner 220B may be implemented in the processor 2111 or the auxiliary processor 2112.

The memory 2120 may store various data used by at least one component (e.g., the processor 2110 or the sensor module 2161) of the electronic device 2101. The various data may include, for example, input data or output data for a command related thereto. The memory 2120 may include at least one of the volatile memory 2121 and the non-volatile memory 2122.

The input module 2130 may receive a command or data to be used by the components (e.g., the processor 2110, the sensor module 2161 or the sound output module 2163) of the electronic device 2101 from the outside of the electronic device 2101 (e.g., the user or the external electronic device 2102).

The input module 2130 may include a first input module 2131 for receiving a command or data from the user and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. In an embodiment, the second input module 2132 may include a high definition multimedia interface (HDMI), a universal serial bus (USB) interface, an SD card interface or an audio interface. The second input module 2132 may include a connector that may physically connect the electronic device 2101 to the external electronic device 2102. For example, the second input module 2132 may include an HDMI connector, a USB connector, an SD card connector or an audio connector (e.g., a headphone connector).

The display module 2140 may visually provide information to the user. The display module 2140 may include the display panel 2141, a scan driver 2142 and the data driver 2143. The display module 2140 may further include a window, a chassis and a bracket for protecting the display panel 2141.

The display panel 2141 may include a liquid crystal display panel, an organic light emitting display panel or an inorganic light emitting display panel, but the type of the display panel 2141 is limited thereto. The display panel 2141 may be a rigid type display panel or a flexible type display panel capable of being rolled or folded. The display module 2140 may further include a supporter, a bracket or a heat dissipation member that supports the display panel 2141.

The scan driver 2142 may be mounted on the display panel 2141 as a driving chip. Alternatively, the scan driver 2142 may be integrated into the display panel 2141. For example, the scan driver 2142 may include an amorphous silicon TFT gate driver circuit (ASG), a low temperature polycrystalline silicon (LTPS) TFT gate driver circuit or an oxide semiconductor TFT gate driver circuit (OSG) embedded in the display panel 2141. The scan driver 2142 may receive a control signal from the controller and may output scan signals to the display panel 2141 in response to the control signal.

The display panel 2141 may further include an emission driver. The emission driver may output an emission control signal to the display panel 2141 in response to a control signal received from the controller. The emission driver may be formed separately from the scan driver 2142 or may be integrated into the scan driver 2142.

The data driver 2143 may receive a control signal from the controller, may convert image data into analog voltages (e.g., data voltages) in response to the control signal and then may output the data voltages to the display panel 2141.

The data driver 2143 may be incorporated into other components (e.g., the controller). Further, the functions of the interface conversion circuit and the timing control circuit of the controller described above may be integrated into the data driver 2143.

The display module 2140 may further include the emission driver, a voltage generator circuit or the like. The voltage generator circuit may output various voltages used to drive the display panel 2141.

The power management module 2150 may supply power to the components of the electronic device 2101. The power management module 2150 may include a battery that charges a power supply voltage. The battery may include a primary cell which is not rechargeable, a secondary cell which is rechargeable or a fuel cell. The power management module 2150 may include a power management integrated circuit (PMIC). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162 and the sound output module 2163. The external module 2170 may include the camera module 2171, a light module 2172 and the communication module 2173.

The sensor module 2161 may detect an input by the user's body or an input by the pen of the first input module 2131 and may generate an electrical signal or data value corresponding to the input. The sensor module 2161 may include at least one of the fingerprint sensor 2161-1, the input sensor 2161-2 and a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen or may transmit/receive data to/from the active pen.

The input sensor 2161-2 may measure a bio-signal, such as blood pressure, moisture or body fat. For example, when a portion of the body of the user touches a sensor layer or a sensing panel and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen or may transmit/receive data to/from the active pen.

At least one of the fingerprint sensor 2161-1, the input sensor 2161-2 and the digitizer 2161-3 may be implemented as a sensor layer formed on the display panel 2141 through a continuous process. The fingerprint sensor 2161-1, the input sensor 2161-2 and the digitizer 2161-3 may be disposed above the display panel 2141 or at least one of the fingerprint sensor 2161-1, the input sensor 2161-2 and the digitizer 2161-3 may be disposed below the display panel 2141.

Two or more of the fingerprint sensor 2161-1, the input sensor 2161-2 and the digitizer 2161-3 may be integrated into one sensing panel through the same process. When integrated into one sensing panel, the sensing panel may be disposed between the display panel 2141 and a window disposed above the display panel 2141. In an embodiment, the sensing panel may be disposed on the window, but the location of the sensing panel is not limited thereto.

At least one of the fingerprint sensor 2161-1, the input sensor 2161-2 and the digitizer 2161-3 may be embedded in the display panel 2141. In other words, at least one of the fingerprint sensor 2161-1, the input sensor 2161-2 and the digitizer 2161-2 may be simultaneously formed through a process of forming elements (e.g., light emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor or an illuminance sensor.

The antenna module 2162 may include one or more antennas for transmitting or receiving a signal or power to or from the outside. In an embodiment, the communication module 2173 may transmit or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing record. The receiver may be used for receiving incoming calls. In an embodiment, the receiver may be implemented as separate from or as part of the speaker. A sound output pattern of the sound output module 2163 may be integrated into the display module 2140.

The camera module 2171 may capture a still image and a moving image. In an embodiment, the camera module 2171 may include one or more lenses, an image sensor or an image signal processor. The camera module 2171 may further include an infrared camera capable of measuring the presence or absence of the user, the user's location and the user's line of sight.

The light module 2172 may provide light. The light module 2172 may include a light emitting diode or a xenon lamp. The light module 2172 may operate in conjunction with the camera module 2171 or may operate independently of the camera module 2171.

The communication module 2173 may support establishing a wired or wireless communication channel between the electronic device 2101 and the external electronic device 2102 and performing communication via the established communication channel. The communication module 2173 may include a wireless communication module (e.g., a cellular communication module, a short-range wireless communication module or a global navigation satellite system (GNSS) communication module) or a wired communication module (e.g., a local area network (LAN) communication module or a power line communication (PLC) module). The communication module 2173 may communicate with the external electronic device 2102 via a short-range communication network (e.g., Bluetooth™, wireless-fidelity (Wi-Fi) direct or infrared data association (IrDA)) or a long-range communication network (e.g., a cellular network, the Internet or a computer network (e.g., LAN or wide area network (WAN)). These various types of communication modules 2173 may be implemented as a single chip or may be implemented as multi-chips separate from each other.

The input module 2130, the sensor module 2161, the camera module 2171 and the like may be used to control an operation of the display module 2140 in conjunction with the processor 2110.

The processor 2110 may output a command or data to the display module 2140, the sound output module 2163, the camera module 2171 or the light module 2172 based on input data received from the input module 2130. For example, the processor 2110 may generate image data corresponding to input data applied through a mouse or an active pen and may output the image data to the display module 2140. Alternatively, the processor 2110 may generate command data corresponding to the input data and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171 or the light module 2172 based on sensing data received from the sensor module 2161. For example, the processor 2110 may compare authentication data applied by the fingerprint sensor 2161-1 with authentication data stored in the memory 2120 and then may execute an application according to the comparison result. The processor 2110 may execute a command or output corresponding image data to the display module 2140 based on the sensing data sensed by the input sensor 2161-2 or the digitizer 2161-3. In a case where the sensor module 2161 includes a temperature sensor, the processor 2110 may receive temperature data from the sensor module 2161 and may further perform luminance correction on the image data based on the temperature data.

The processor 2110 may receive measurement data about the presence or absence of the user, the location of the user and the user's line of sight from the camera module 2171. The processor 2110 may further perform luminance correction on the image data based on the measurement data. For example, after the processor 2110 determines the presence or absence of the user based on the input from the camera module 2171, the data conversion circuit 2112-2 or the gamma correction circuit 2112-3 may perform the luminance correction on the image data and the processor 2110 may provide the luminance-corrected image data to the display module 2140.

At least some of the above-described components may be coupled mutually and communicate signals (e.g., commands or data) therebetween via an inter-peripheral communication scheme (e.g., a bus, general purpose input and output (GPIO), serial peripheral interface (SPI), mobile industry processor interface (MIPI) or ultra-path interconnect (UPI)). The processor 2110 may communicate with the display module 2140 via an agreed interface. Further, any one of the above-described communication methods may be used between the processor 2110 and the display module 2140, but the communication method between the processor 2110 and the display module 2140 is not limited to the above-described communication method.

The electronic device 2101 according to various embodiments described above may be various types of devices. For example, the electronic device 2101 may include at least one of a portable communication device (e.g., a smart phone), a computer device, a portable multimedia device, a portable medical device, a camera, a wearable device and a home appliance. However, the electronic device 2101 according to embodiments is not limited to the above-described devices.

The display device according to the embodiments may be applied to a display apparatus included in a computer, a notebook, a mobile phone, a smart phone, a smart pad, a PMP, a PDA, an MP3 player, or the like.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. An electronic device comprising:
a beam splitter;
a display device configured to output an image to the beam splitter; and
an angle controller configured to control an angle of a display panel included in the display device,
wherein the display device includes:
the display panel, which includes a first display region and a second display region;
a data driver configured to apply a data voltage based on a data signal to the display panel;
a gate driver configured to output a gate signal to the display panel; and
a driving controller configured to output the data signal to the data driver,
wherein a region angle, which is an angle between the first display region and the second display region, is changed based on an angle control signal, and
wherein the driving controller changes a setting luminance of at least one of the first display region and the second display region based on the angle control signal.

2. The electronic device of claim 1, wherein when a portion of the region angle, which is an angle between a current position of the second display region and a reference position of the second display region, has a first region angle, the second display region emits light based on a first setting luminance, and
wherein when the portion of the region angle is changed from the first region angle to a second region angle higher than the first region angle, a white color coordinate corresponding to white color of the second display region is changed from a first white color coordinate corresponding to the first region angle to a second white color coordinate different from the first white color coordinate.

3. The electronic device of claim 2, wherein an X-axis coordinate of the second white color coordinate is lower than an X-axis coordinate of the first white color coordinate, and a Y-axis coordinate of the second white color coordinate is lower than a Y-axis coordinate of the first white color coordinate.

4. The electronic device of claim 3, wherein when the portion of the region angle has a third region angle higher than the second region angle, the white color coordinate is changed to a third white color coordinate different from the second white color coordinate.

5. The electronic device of claim 4, wherein an X-axis coordinate of the third white color coordinate is lower than the X-axis coordinate of the second white color coordinate, and a Y-axis coordinate of the third white color coordinate is higher than the Y-axis coordinate of the second white color coordinate.

6. The electronic device of claim 5, wherein when the portion of the region angle has a fourth region angle higher than the third region angle, the white color coordinate is changed to a fourth white color coordinate different from the third white color coordinate.

7. The electronic device of claim 6, wherein an X-axis coordinate of the fourth white color coordinate is higher than the X-axis coordinate of the third white color coordinate, and a Y-axis coordinate of the fourth white color coordinate is higher than the Y-axis coordinate of the third white color coordinate.

8. The electronic device of claim 1, wherein when the portion of the region angle has a first region angle, the second display region emits light based on a first setting luminance, and
wherein when the portion of the region angle has a second region angle higher than the first region angle, the second display region emits light based on a second setting luminance higher than the first setting luminance.

9. The electronic device of claim 8, wherein when the portion of the region angle has a third region angle higher than the second region angle, the second display region emits light based on a third setting luminance higher than the second setting luminance.

10. The electronic device of claim 1, wherein the driving controller includes:
an angle data receiver configured to output an angle information signal based on region angle data;
a luminance change determiner configured to output luminance compensation data corresponding to the region angle based on the angle information signal; and
a data signal outputter configured to output the data signal based on the luminance compensation data.

11. The electronic device of claim 10, wherein the luminance compensation data is generated based on a luminance compensation look-up table.

12. The electronic device of claim 1, wherein the driving controller includes:
an angle data receiver configured to output an angle information signal based on region angle data;
a color coordinate change determiner configured to output color coordinate compensation data corresponding to the region angle based on the angle information signal; and
a data signal outputter configured to output the data signal based on the color coordinate compensation data.

13. The electronic device of claim 12, wherein the color coordinate compensation data is generated based on a color coordinate compensation look-up table.

14. The electronic device of claim 1, wherein the display panel further includes a third display region, and
wherein an angle between the first display region and the third display region is changed based on an angle control signal.

15. The electronic device of claim 1, wherein the beam splitter outputs a three-dimensional image.

16. The electronic device of claim 1, wherein the region angle is changed in real-time.

17. A display device comprising:
a display panel including a first display region and a second display region;
a data driver configured to apply a data voltage based on a data signal to the display panel;
a gate driver configured to output a gate signal to the display panel; and
a driving controller configured to output the data signal to the data driver,
wherein a region angle, which is an angle between the first display region and the second display region, is changed based on an angle control signal, and
wherein the driving controller changes a setting luminance of at least one of the first display region and the second display region based on the angle control signal.

18. The display device of claim 17, wherein when the a portion of the region angle, which is an angle between a current position of the second display region and a reference position of the second display region, has a first region angle, the second display region emits light based on a first setting luminance,
wherein when the portion of the region angle is changed from the first region angle to a second region angle higher than the first region angle, a white color coordinate corresponding to white color of the second display region is changed from a first white color coordinate corresponding to the first region angle to a second white color coordinate different from the first color coordinate, and
wherein an X-axis coordinate of the second white color coordinate is lower than an X-axis coordinate of the first white color coordinate, and a Y-axis coordinate of the second white color coordinate is lower than a Y-axis coordinate of the first white color coordinate.

19. A method of operating a display panel comprising:
receiving region angle data;
determining color coordinate compensation data based on the region angle data; and
outputting a data signal based on the color coordinate compensation data,
wherein the color coordinate compensation data is generated based on a color coordinate compensation look-up table,
wherein when a region angle of a display region included in a display panel is changed from the first region angle to a second region angle higher than a first region angle, a white color coordinate corresponding to white color of the display region is changed from a first white color coordinate corresponding to the first region angle to a second white color coordinate different from the first color coordinate, and
wherein an X-axis coordinate of the second white color coordinate is lower than an X-axis coordinate of the first white color coordinate, and a Y-axis coordinate of the second white color coordinate is lower than a Y-axis coordinate of the first white color coordinate.

20. The method of claim 19, wherein when the region angle of the display region has a third region angle higher than the second region angle, the white color coordinate is changed to a third white color coordinate different from the second white color coordinate, and
wherein an X-axis coordinate of the third white color coordinate is lower than the X-axis coordinate of the second white color coordinate, and a Y-axis coordinate of the third white color coordinate is higher than the Y-axis coordinate of the second white color coordinate.
